(19) United States
(12) Patent Application Publication
(10) Pub. No.: US 2003/0216845 A1
(43) Pub. Date: Nov. 20, 2003

(54) Automatic tire inflation based on vehicle loading conditions

(76) Inventor: Scott Lawton Williston, Rochester Hills, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/146,614

(22) Filed: May 15, 2002

(51) Int. Cl. B60C 23/02

(52) U.S. Cl. 701/36; 340/442

(57) ABSTRACT

A tire pressure control system for a vehicle including a vehicle frame, at least one axle, a tire coupled to the axle, a tire pressure sensor sensing pressure in the tire, a load sensor sensing the load on the axle, a controller electronically coupled to the tire pressure sensor and the load sensor, and a compressor pneumatically coupled to the tire and controlled by the controller to maintain a desired tire pressure for the load.

### TECHNICAL FIELD

The present invention relates generally to vehicle load monitoring. More specifically, the present invention relates to a method and apparatus to monitor and control tire inflation based on vehicle load and environmental conditions.

### BACKGROUND OF THE INVENTION

Tire pressure is an important variable in vehicle ride and handling. From a handling perspective, maintaining proper tire pressure is often ignored by the operator of a vehicle. Tire pressure will vary as a function of temperature and loading conditions and will be directly affected by the maintenance practices of a vehicle operator. The purpose of adjusting tire pressures and other suspension components is to maximize tire contact and the grip of the vehicle on a road surface and optimize the handling performance of a vehicle. Vehicle loading also can affect tire grip and the handling performance of a vehicle.

Tire pressure impacts vehicle ride performance in a number of ways. The ride performance of a vehicle can typically be improved by allowing relatively lower tire pressures at low loading conditions, while relatively higher pressures are required for high loading conditions. Vehicle tire pressures are specified to compensate for the load rating of the vehicle. In large load-carrying vehicles, higher tire pressures are required. These higher pressures for heavily loaded conditions result in degraded ride performance at low load conditions.

In general, customers are not advised to change tire pressures for specific loading. This is because of the difficulty in identifying the specific load being carried and adjusting the tire pressures accordingly, and then readjusting the pressures as the vehicle loading changes (i.e., being unloaded). Manufactures generally recommend tire pressures at the maximum for the heaviest loading condition.

Ambient temperature also affects tire pressure according to the ideal gas laws. As ambient temperature goes up, tire pressure will go up, and as ambient temperature decreases, tire pressure will decrease. Accordingly, variations in tire dynamics caused by changes in ambient temperature can affect the tire grip, ride, and handling of a vehicle. There is presently a need in the art to compensate for large variations in vehicle loading conditions and variations in ambient temperature for vehicle tire pressure, as well as to compensate for a lack of attention by the operator of a vehicle with reference to recommended tire pressures.

### SUMMARY OF THE INVENTION

The present invention includes a method and apparatus utilizing a controller, air compressor, load monitoring system, ambient temperature sensors, operator indicators, and a tire inflation system to control and maintain tire pressures for a vehicle. The present invention will automatically inflate or deflate vehicle tires for specific vehicle loading. The present invention further automatically adjusts and maintains tire pressures to compensate for tire leaks and for variations in ambient temperature, and will inform the operator of the vehicle of a potential tire leak.

In an alternate embodiment of the present invention, the present invention will report a recommended tire pressure to a vehicle operator for a vehicle loading condition and allow the operator to manually adjust the tire pressures.

### BRIEF DESCRIPTION OF THE DRAWINGS

FIG. 1 is a diagrammatic drawing of a vehicle including the tire pressure control system of the present invention; and

FIG. 2 is a diagrammatic drawing of an axle and vehicle suspension.

### DESCRIPTION OF THE PREFERRED EMBODIMENT

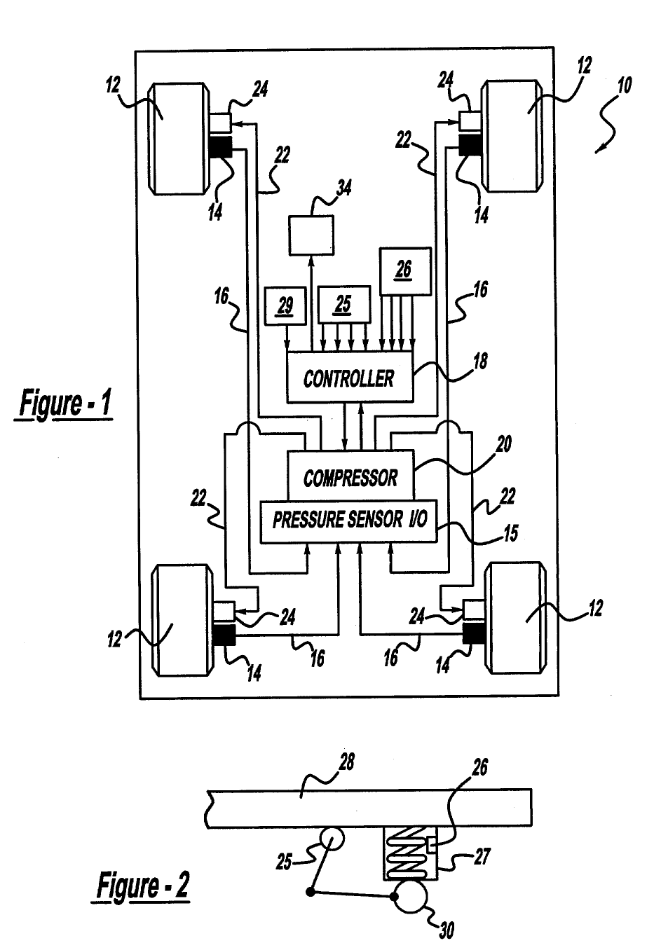

FIG. 1 is a diagrammatic drawing of a vehicle 10 having four tires 12, front left (FL), rear left (RL), rear right (RR), and front right (FR), as is known in the art. A tire pressure sensor 14 is coupled to each tire 12 to monitor tire pressure. The tire pressure sensors 14 may comprise strain gauges, piezoelectric transducers, capacitive transducers, and any other known pressure transducers in the art. In FIG. 1, the tire pressure sensors 14 are shown electrically coupled to a pressure sensor input/output (I/O) block 15 by wires 16. In alternate embodiments of the present invention, the tire pressure sensors 14 may communicate tire pressure information via a wireless transmission to a controller 18 in the vehicle or the tire pressure sensors 14 may be directly wired to the controller 18.

The controller 18 is in communication with the pressure sensor I/O block 15 to process the inputs from the tire pressure sensors 14. An air compressor 20 is controlled by the controller 18 and coupled via pneumatic lines 22 to the tires 12 by a rotary air couplings 24. Airflow through the pneumatic lines 22 may be controlled by an array of solenoid valves (not shown) to allow independent deflation and inflation of each tire 12.

Referring to FIGS. 1 and 2, the controller 18 may further receive vehicle loading information from a position sensor 25 and pressure sensors 26 from an air shock system 27. The pressure sensor 26 may be comprised of a sensor similar to the tire pressure sensors 14. The position sensor 25 senses the position of a vehicle frame 28 relative to an axle 30. As the load on the frame 28 increases, the suspension will typically compress and the distance between the vehicle frame 28 and axle 30 will decrease. The position sensor 25 may comprise a potentiometer, encoder, or any other position sensor known in the art, but is not limited to such. The position sensor 25 data and/or pressure sensor 26 data is processed to correlate to a vehicle load value condition. This vehicle load condition corresponds to a specific tire pressure that is stored in a calibration table of the controller 18 that optimizes the ride and handling of the vehicle 10. Each tire 12 can be controlled independently in this fashion to optimize the ride and handling of the vehicle, as loads may not be evenly distributed in the vehicle 10.

The controller 18 in the preferred embodiment will measure the ambient temperature with an ambient temperature sensor 29, the load on each tire 12 of the vehicle 10, and independently control the tire pressure 12 in each tire with respect to the load and ambient temperature. The controller 18 will also monitor tire pressure for a rate of decay (leaks). The controller 18 will continue to adjust pressure until a threshold leak rate is obtained and the compressor 20 cannot keep up with the leak. The controller 18 will then inform the operator of the vehicle 10 via indicator 34 when a tire 12 needs replacement due to a slow leak. Leakage is determined by the controller as a function of how often the tire 12 is filled by the compressor 20.

In an alternate embodiment of the present invention, the controller will measure the load, via the position sensor 25, and recall from a calibration in the controller 18 the recommended tire pressures for the vehicle to be displayed on the indicator 34. In this manner, the operator of the vehicle 10 may manually control the pressure of the tires 12 without the intervention of a compressor 20 or a tire inflation system. The operator may select an automatic or manual tire pressure control during the operation of the vehicle 10.

While this invention has been described in terms of some specific embodiments, it will be appreciated that other forms can readily be adapted by one skilled in the art. Accordingly, the scope of this invention is to be considered limited only by the following claims.

1. A tire pressure control system for a vehicle comprising:
a vehicle frame;
at least one axle;
a tire coupled to said at least one axle;
a tire pressure sensor sensing pressure in said tire;
a load sensor sensing the load on said at least one axle;
a controller electronically coupled to said tire pressure sensor and said load sensor; and
a compressor pneumatically coupled to said tire and controlled by said controller to maintain a desired tire pressure for said load.

2. The tire pressure control system of claim 1 further comprising an ambient temperature sensor.

3. The tire pressure control system of claim 1 further comprising a plurality of tires, a plurality of tire pressure sensors, and a plurality of load sensors.

4. The tire pressure control system of claim 1 further comprising an air suspension system equipped with an air pressure sensor to indicate load on said air suspension system.

5. The tire pressure control system of claim 1 further comprising a calibration table containing desired tire pressures based on load.

6. The tire pressure control system of claim 1 further comprising a calibration table containing desired tire pressures based on ambient temperature.

7. The tire pressure control system of claim 1 further comprising a feedback device coupled to said controller to inform an operator of leak condition.

8. A method of controlling tire pressure in a tire comprising:
monitoring tire pressure in the tire;
monitoring load on the tire;
determining a desired tire pressure from the monitored load; and
generating said desired pressure in the tire.

9. The method of claim 8 further comprising the step of monitoring ambient temperature.

10. The method of claim 8 further comprising the step of providing a calibration table correlating the monitored load to a desired tire pressure.

11. The method of claim 8 further comprising the step of indicating to an operator of a vehicle a desired tire pressure.

12. A tire pressure control system for a vehicle comprising:
a vehicle frame;
at least one axle;
a tire coupled to said at least one axle;
a load sensor sensing the load on said at least one axle;
a controller electronically coupled to said load sensor; and
a tire pressure indicator coupled to said controller, wherein a recommended tire pressure is displayed on the indicator.

13. The tire pressure control system of claim 12 further comprising a plurality of tires, a plurality of tire pressure sensors, and a plurality of load sensors, wherein said tire pressure indicator displays recommended tire pressures for each of said plurality of tires.

14. The tire pressure control system of claim 12 wherein said controller includes a calibration table linking measured tire loads to recommended tire pressures.

15. The tire pressure control system of claim 12 wherein said controller includes a function to process measured tire loads into recommended tire pressures.
